(19) United States
(12) Patent Application Publication
(10) Pub. No.: US 2017/0107748 A1
(43) Pub. Date: Apr. 20, 2017

(54) Mechanism at Pivoting Window

(71) Applicant: Hans Öhman, Västra Frölunda (SE)

(72) Inventor: Hans Öhman, Västra Frölunda (SE)

(21) Appl. No.: 15/127,013

(22) PCT Filed: Mar. 10, 2015
(86) PCT No.: PCT/SE2015/050268

§ 371 Date: Sep. 17, 2016

(30) Foreign Application Priority Data
Mar. 28, 2014 (SE) 1450363-5

(51) Int. Cl. E05D 15/50; E05F 11/10; E05C 9/14; E05D 15/46; E05D 15/44

(52) U.S. Cl. CPC E05D 15/50; E05D 15/466; E05D 15/44; E05C 9/14; E05F 11/10

(57) ABSTRACT

The invention concerns a mechanism (1) for a window (2), which is displaceably guided along grooves (4) and mounted pivotably 180° and 360° around a horizontal bearing spindle (5) and which comprises means (6 and 7, respectively) for the guiding and locking, respectively, of the window (2). According to the invention, a single handle (10) or another lever is situated or coupleable in the frame (8) or casement (9) of the window is connected with said locking means (7) for the window (2) and/or is connectable with said guiding means (6) for the window (2), whereby the locking and guiding, respectively, of the window is arranged to be provided by said single handle (10) or lever.

The present invention concerns a mechanism at a window, which is displaceably guided along grooves and mounted pivotably 180° and 360° around a horizontal bearing spindle and which comprises means for the guiding and locking, respectively, of the window.

There are a number of different solutions to windows and the mechanism to be able to open, close, lock, and unlock said windows. Many of said mechanisms are complicated both as regards their design and construction as well as their handling. Many times, it is required to handle said mechanisms by two hands and then there is no hand free for manoeuvring the window to a desired position in a simple and reliable way.

Therefore, the main object of the present invention is primarily to provide a window mechanism of the type mentioned, which is both simple in the design and its construction and which is suitable to be adjusted by a single lever, for instance a handle.

Said object is achieved by means of a mechanism of the above-mentioned kind, which essentially is characterized in that a single handle or another lever situated or coupleable in the frame or casement of the window is connected with said locking means for the window and/or is connectable with said guiding means for the window, that paired [-shaped guide frames for manual actuation of desired guide pins, and connected with said respective guide frame, are situated along the casement of said window, counter-directed to each other with their open portions, that upper and lower, respectively, guide pins projecting in the horizontal direction from the respective guide frame are receivable guidable by parallel guide grooves extending along the opening of the window, that said guide frames are interconnected via a motion connection, which upon actuation is alternately arranged to actuate said paired guidings at the upper and lower, respectively, halves of the window to allow the turning around of the window during simultaneous guiding by means of paired guidings, that the guidings are formed of horizontally movable pins or the like uprights, which are connected with paired bars, which via a number of pivotably mounted links are interconnected at the upper and lower, respectively, portions of the window, received in guide grooves, for simultaneous parallel motion out and in, respectively, whereby the locking and guiding, respectively, of the window are arranged to be provided by said single handle or lever.

An example of the invention is described below, reference being made to the accompanying drawings in which,

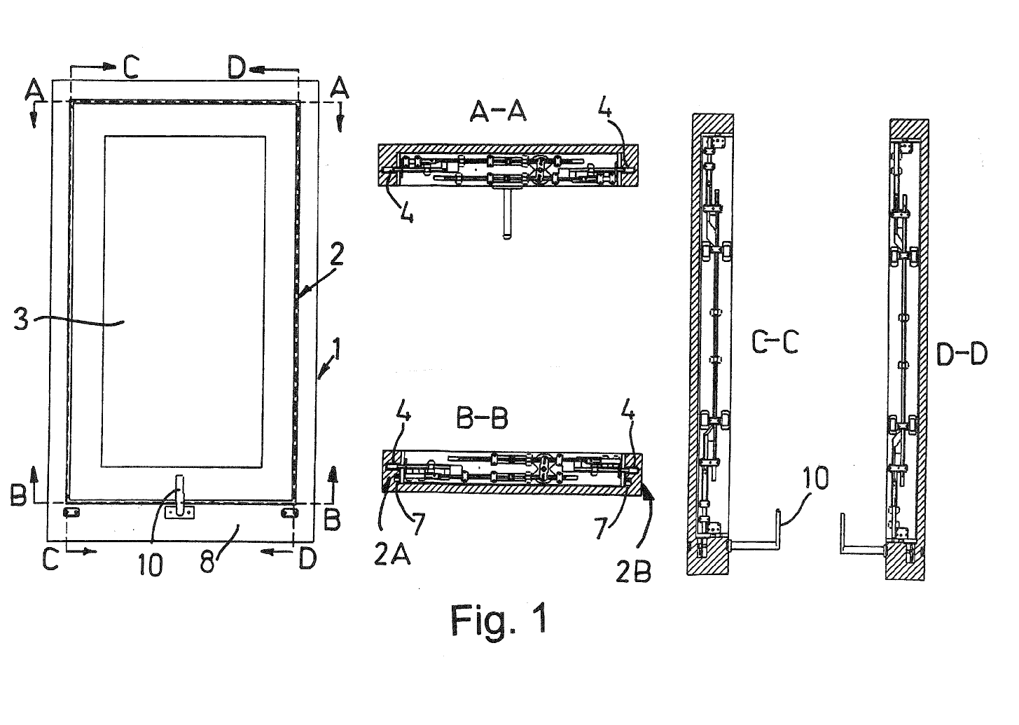

FIG. 1 shows a front view of a closed window as seen from inside a building as well as with section views A-A-D-D showing the mechanism inside said window,

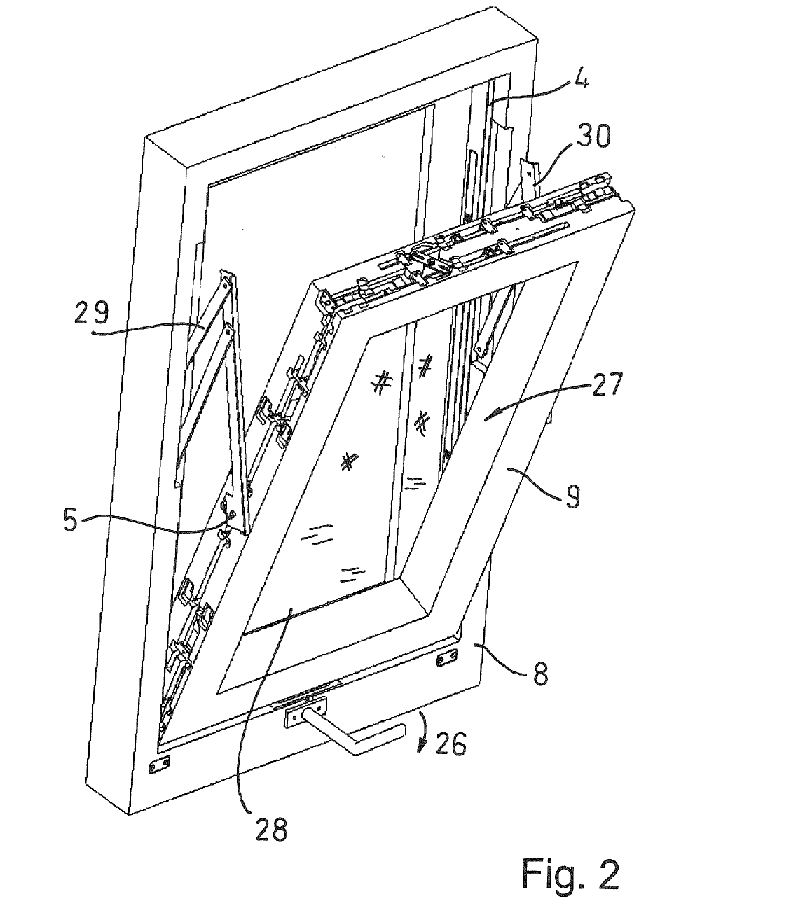

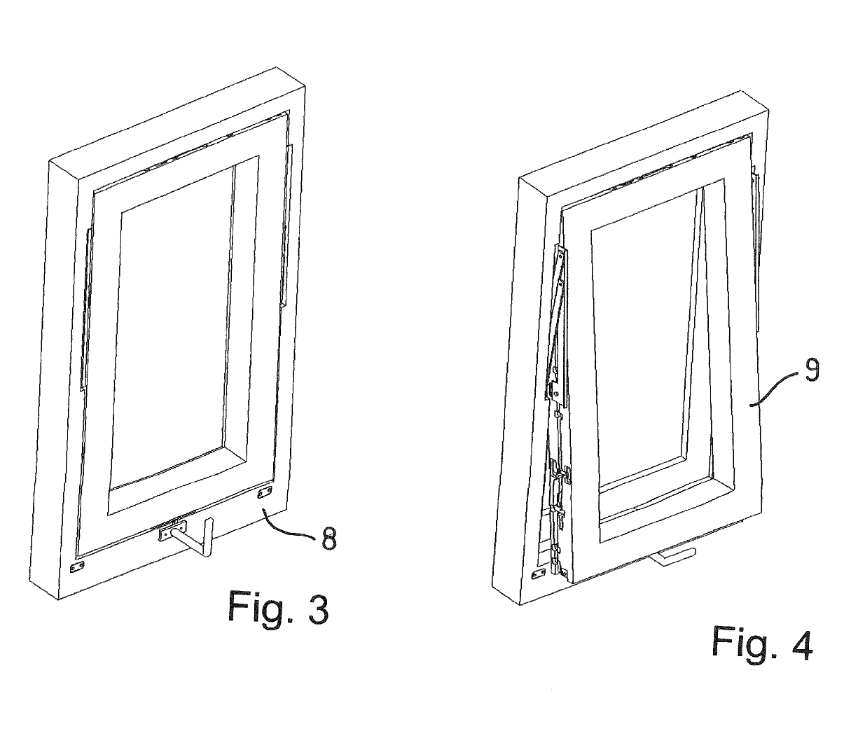

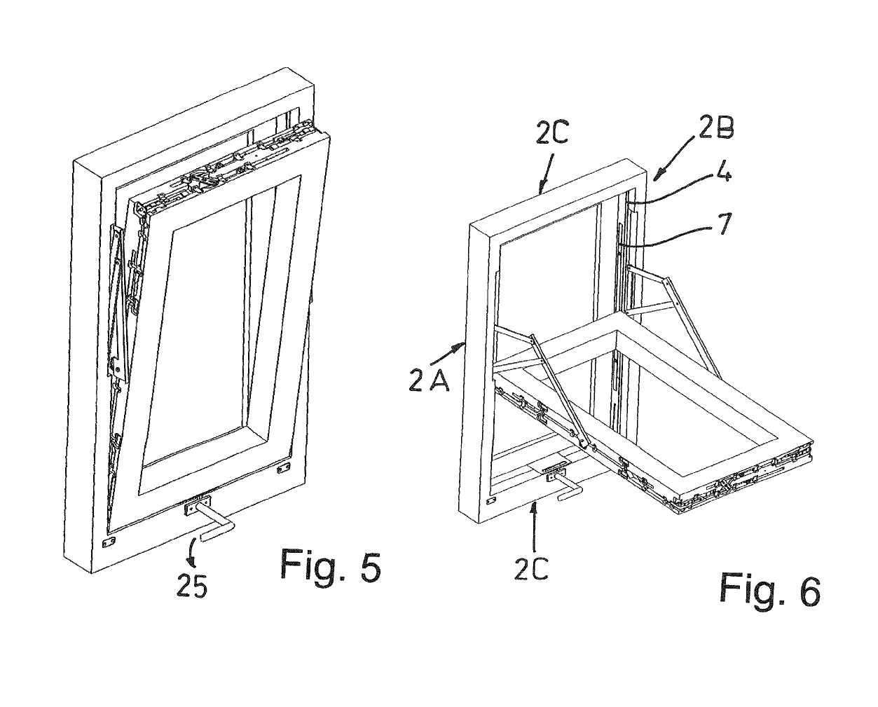

FIGS. 2-6 show the window actuated by the mechanism to be set in different opening positions as in closed position,

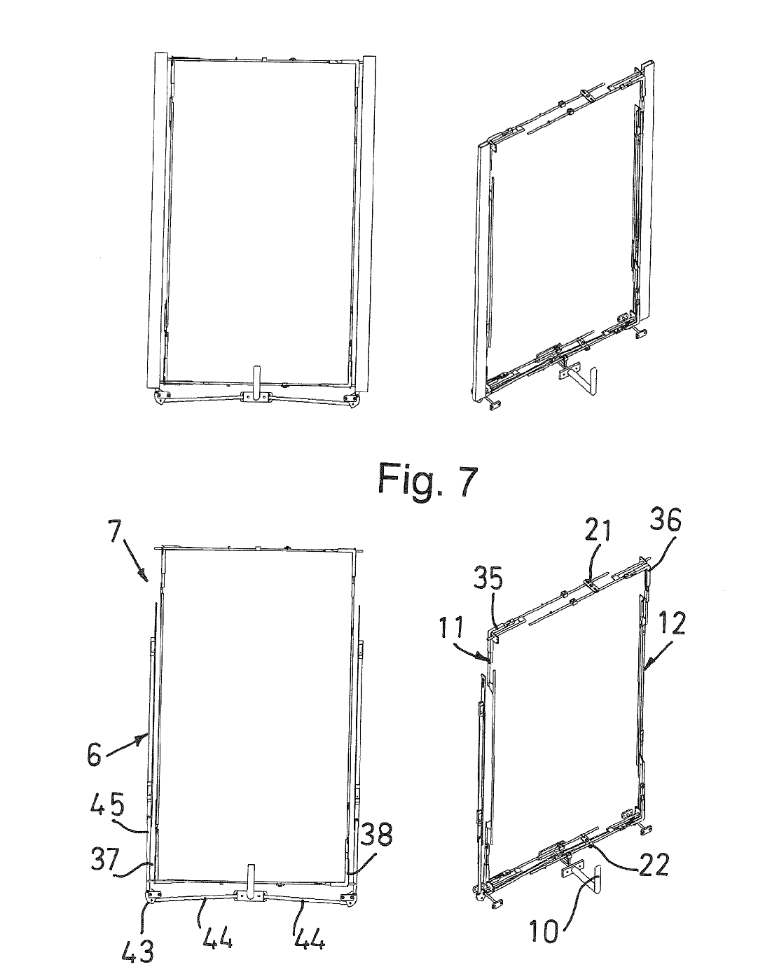

FIG. 7 shows the mechanism of the window in active locking position,

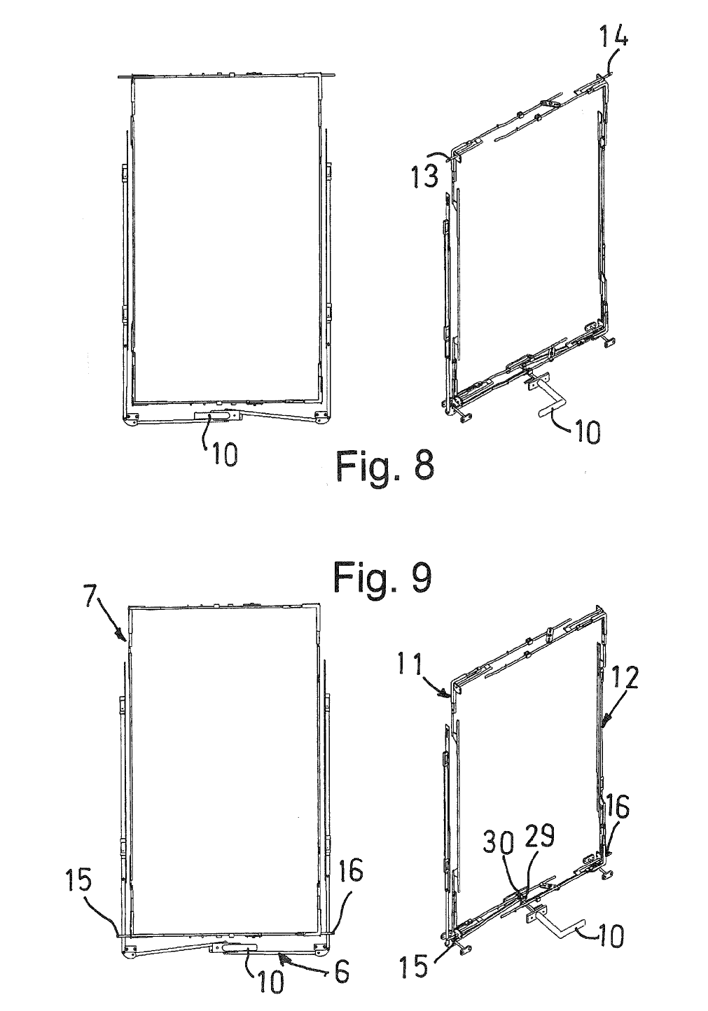

FIG. 8 shows the mechanism in position for opening the window at the bottom,

FIG. 9 shows the mechanism in position for opening the window at the top,

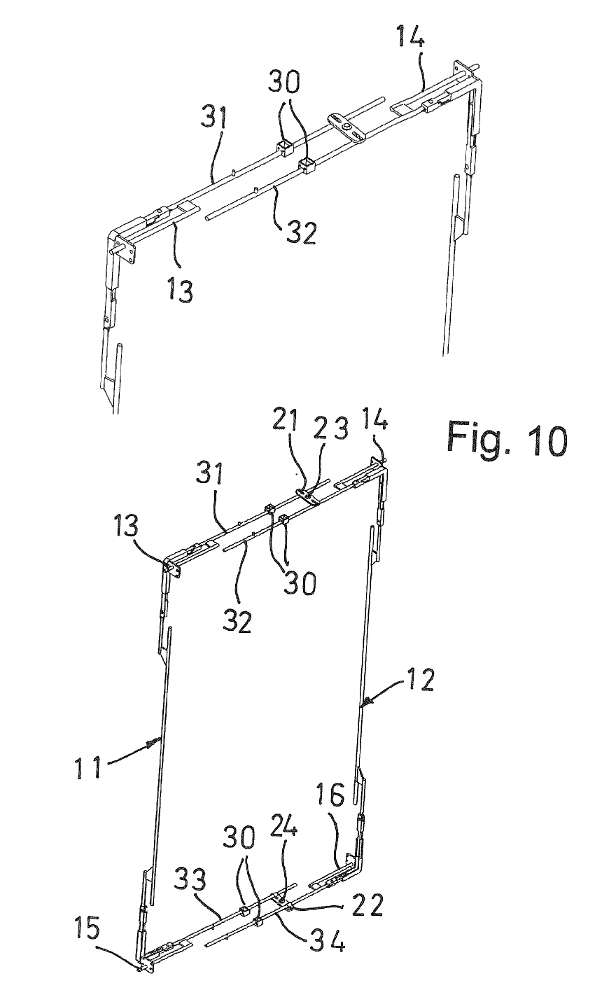

FIG. 10 shows the mechanism and the guiding means thereof in active engagement positions both at the top and at the bottom of the window and with the active upper portion of the mechanism shown in more detail,

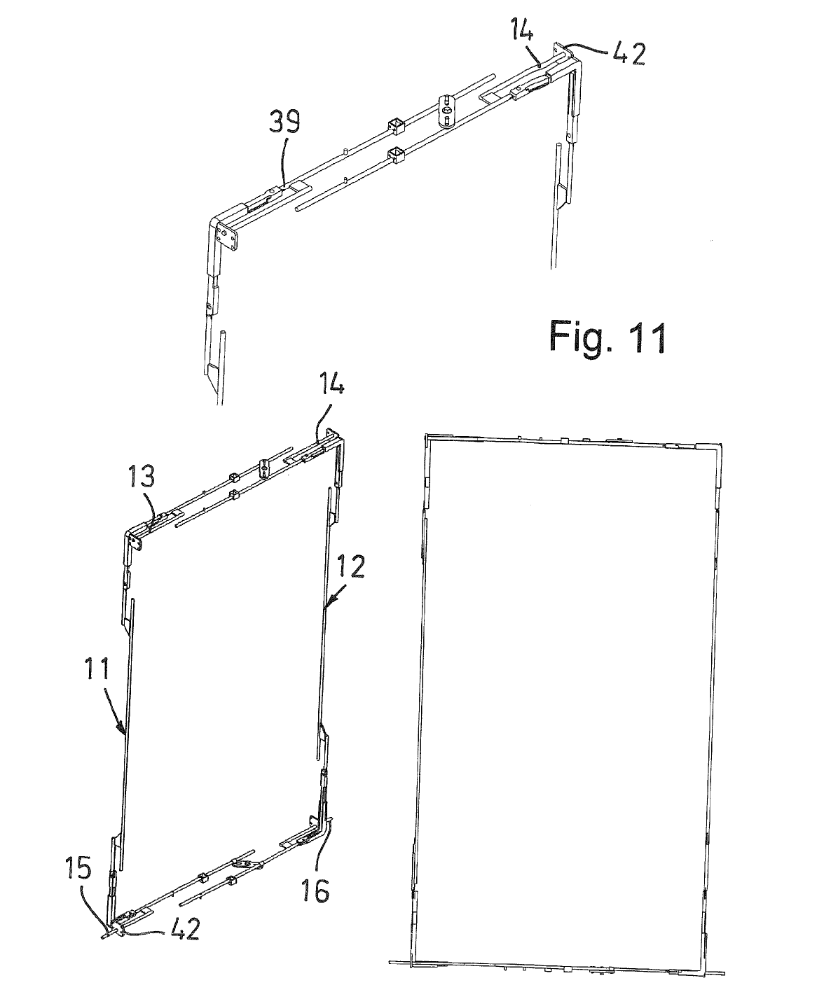

FIG. 11 shows the mechanism and the guiding means thereof in active engagement position at the bottom of said window and with the inactive upper portion of the mechanism shown in more detail,

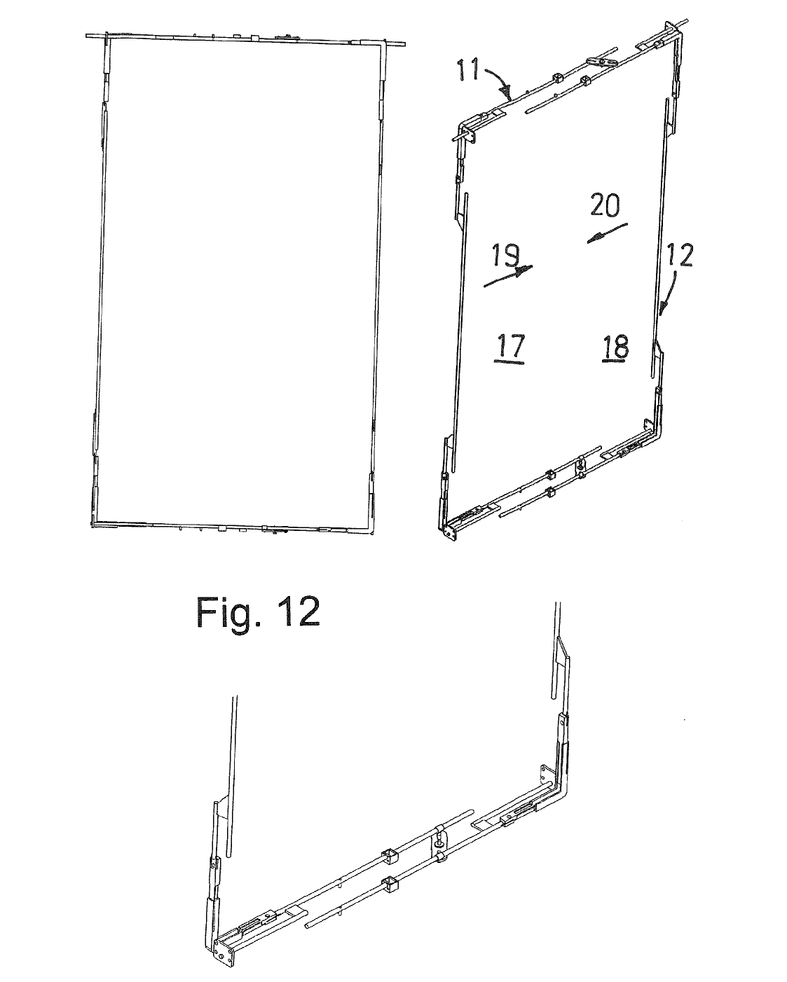

FIG. 12 shows the mechanism and the guiding means thereof in active engagement position at the top of said window and with the inactive lower portion of the mechanism shown in more detail and allowing window opening at the bottom, and

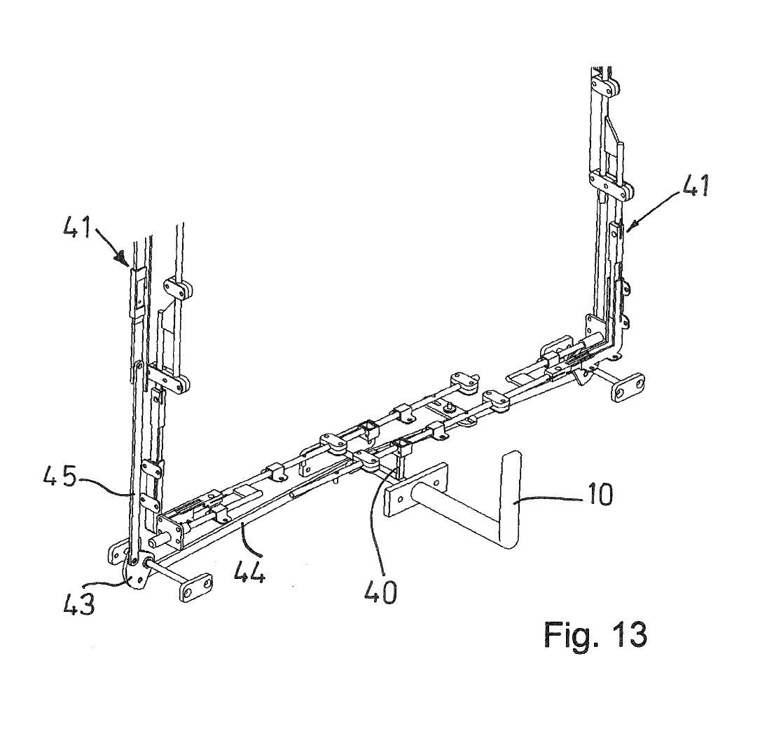

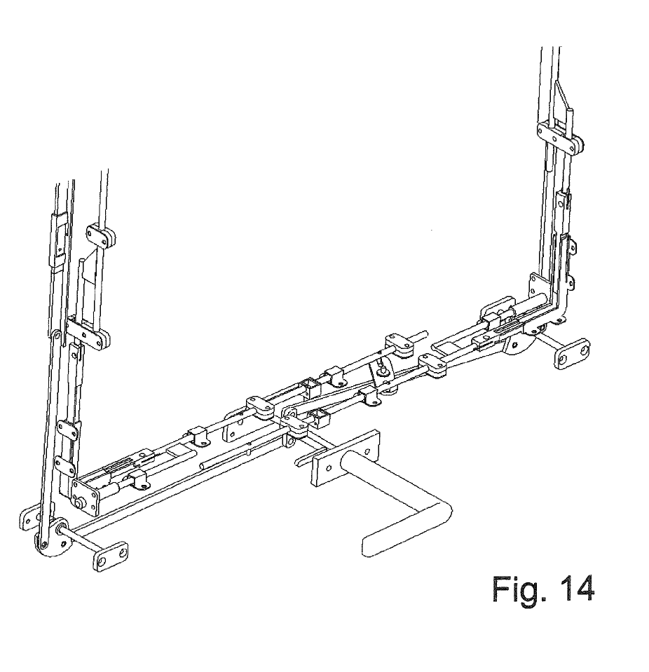

FIGS. 13 and 14 show the mechanism in two different positions after actuation of a lever.

The mechanism allows controlling by a single handle or lever an occurring locking mechanism as well as guiding mechanism for window so that said window without obstacles can be turned 180° and 360° according to desire and need.

More precisely, a mechanism 1 is formed for a window 2, of preferably the kind that is provided with or treated on its one side 3 with energy increasing means preventing the sun from shining straight into a room and in an undesired way increasing the temperature above pleasant temperature, e.g., a reflecting or in another way working temperature reducing means therefor, of known type. For instance, a said window 2 is displaceably guided along grooves 4 and mounted pivotably 180° and 360° around a horizontal bearing spindle 5 and which comprises means 6 and 7, respectively, for the guiding and locking, respectively, of the window 2.

According to the invention, a said mechanism 1 is formed of a single handle 10 or another lever, situated or, e.g., detachably coupleable in the frame 8 or casement 9 of the window, and which, e.g., is fixedly connected with said locking means 7 for the window 2 and/or, e.g., is detachably connected with said guiding means 6 for the window 2, whereby the locking and guiding, respectively, of the window are arranged to be provided by said single handle 10 or lever.

Said locking means 7 for the window 2, and which, e.g., may be formed of previously known locking cremone bolts or of other locking means comparable therewith, are placed on a respective opposite side of the window extending along the paired horizontal and/or vertical sides 2A, 2B, 2C, 2D of the window. Alternatively, said locking means 7 may be formed of locking pins, which are interconnected with means for the guiding of the window 2, which, however, is not shown.

Paired [-shaped guide frames 11, 12 are present, which are arranged and intended for manual actuation of desired guide pins 13-16 etc. The paired upper and lower, respectively, horizontally projecting guide pins 13-14 and 15-16, respectively, or other suitable guidings, are arranged to project horizontally from the respective guide frame 11, 12, to be receivable and guidable by parallel guide grooves 4, which extend on each side of the casement 9 of a window. Said guide frames 11, 12 are counter-directed to each other 19, 20 with their open portions 17, 18.

Said two guide frames 21, 12 are interconnected via a motion connection 21, 22, which preferably is formed of one or more links fixedly connected with the upper and lower, respectively, portions of the respective guide frames 11, 12 and pivotably mounted around a respective bearing spindle 23, 24 in the casement 9. Upon manual actuation of the handle 10 in either direction of rotation 25, 26, said motion connections 21, 22 are arranged to actuate said paired guidings 13-16, which are situated at the upper and lower, respectively, halves of the window. Upper and lower positions vary depending on the casement 9 of the window with the appurtenant cassette 27 preferably having triple-glazed packages 28 being pivoted around the appurtenant pivot spindle 5, which is supported by known support arms 29, 30 on each side of casement 9 and frame 8. Upon said actuation, the casement 9 is guided by means of said guide pins 13-16, which are guided in the appurtenant guide grooves 4 along the casement at one upper or lower end of the casement, however never simultaneously during movement of the casement 9.

Said single handle/lever 10 is arranged connectable with a said motion connection in the area of said handle/lever, e.g. by an actuation arm 29 or another similar pivotable arm or pin, which engages with a joint 30.

The guidings 13-16 are formed of horizontally movable pins or the like uprights, which are connected with paired bars 31-34, which via said pivotably mounted links 21, 22 are interconnected at the upper and lower, respectively, portions of the window, received in guide grooves 4, for simultaneous parallel motion out and in, respectively, at the upper and lower, respectively, part of the window, in pairs simultaneously.

In the corners of said guide frames 11, 12, motion transfer means 35-38 are arranged to deflect straight motion essentially 90°, and said motion transfer means 35-38 are connected with a projecting part 39 of the bars 31-34.

Thus, by the present invention, it is possible to, by a single handle, control locking mechanism 7 and guiding mechanism 6 for a window 2, which allows turning the window 180° and 360°.

The guiding of the window 2 is carried out by means of two guide pins 13-14 in the upper edge and two guide pins 15-16 in the lower edge, respectively, of the window casement 9. The guide pins 13-16 slide in a profile along the sides of the window frame. These are guided by means of two half-looped guide frames 11, 12 with guide grooves 4 along the window casement 9. These run in the opposite direction of three sides of the window casement 9. The transitions in the corners of the window casement are possible to realise by different technical solutions, e.g. by spring steel sliding in a groove or by guide arms with pivot point. Two half loops of guide rails are interconnected with a guide mechanism making that they run in the opposite direction. The guide mechanism may be formed in various ways, e.g. with gearwheels, with strip of spring steel sliding in a groove, or with an arm with a pivot point in the middle.

The handle 10 is fitted on the window frame 8 or on the casement 9 and has a guide arm 40 which enters into the window casement and guides one of the two half loops of the guide rails 6. The second half loop gets its counter-directed motion by means of the mechanism linking together the half loops. The two half loops with the guide rails are symmetrical so that when the window is rotated 180°, the joint 30 for the guide arm 40 of the handle ends up in the same position as the corresponding recess for the guiding arm 40 of the handle has on the other half loop with guide rails moving in the opposite direction.

Opening and closure of the window 2 is carried out as has been said by means of cremone bolts 41, which are fitted in the window frame. When the handle 10 is in the intermediate position and the guide rails are semi engaged, then the cremone bolts 41 are in full engagement and hold the window in closed position. When the handle 10 is moved to one of the two end positions, then a selection is made if it is desired that the upper guide pins 13-14 or the lower guide pins 15-16, respectively, should guide the window 2. Simultaneously, the cremone bolts 41 are pulled into the window frame 8 and the window 2 is suspended in the hinge arms 29 and is guided by the upper and lower guide pins 13-14. Fittings for the cremone bolts in the window casement 9 are symmetrical so that it is possible to rotate the window 180° and then close the window. When the handle 10 is moved from open position to the intermediate position (closed position), the two half-looped guide arms 11, 12 with guide rails in the window casement 9 are moved to neutral position and the guide pins 13-16 assume half engagement in the guide groove 4 in the window frame 8. Simultaneously, the cremone bolts are going out from the window frame into the window casement and lock the window in closed position. Guidings 42 for the guide pins 13-16 are arranged in the corners of the window and may be formed of sheet-metal plates having holes for the respective guide pin 13-16. The cremone bolts are actuated thanks to angle transfer in the corners, e.g. in the form of pivotable cam mechanism 43 shown to which arms 44, 45 are connected for linear motion actuation. Coverage of said mechanisms, at least at upper and lower window casement portions may be provided by cover lids, etc. not shown.

It is possible to replace the cremone bolts with locking pins, which are fitted on the two half loops with guide rails. When the handle then is in its middle position, the locking pins are located behind stop blocks and the window is closed. The handle is moved to one of two end positions to choose if the window should be guided by the upper or the lower, respectively, guide pins. The locking pins are then moved so that they end up underneath and above, respectively, the lock blocks. When the window is being closed and the handle brought to the mid-position, the locking pins return and position behind the stop blocks, at the same time as the guide pins return to the neutral position and are semi engaged and the window is closed.

The nature and the function of the invention are clearly seen from what is mentioned above and shown in the drawings, but the invention is naturally not limited to the embodiments described above and shown in the accompanying drawings. Modifications are feasible, particularly as for the nature of the different parts, or by using an equivalent technique, without departing from the protection area of the invention, such as it is defined in the claims.

1.-6. (canceled)

7. A mechanism for a window (2), which is displaceably guided along guide grooves and pivotably mounted around a horizontal bearing spindle and which includes devices for guiding and locking, respectively, the window, the mechanism comprising:
a single handle or lever in the window frame or casement, the single handle or lever being connected with the device for locking the window and configured for connection to the device for guiding the window and the device for guiding the window including guide pins for the window; and
paired [-shaped guide frames for manual actuation of selected guide pins connected with the respective guide frames, the [-shaped guide frames being situated along the window casement with their open portions counter-directed to each other;
wherein upper and lower guide pins projecting in a horizontal direction from respective [-shaped guide frames are guidably received by parallel guide grooves extending along an opening of the window;
the [-shaped guide frames are interconnected via a motion connection, which upon actuation, is arranged to actuate alternately paired guide pins at respective upper and lower halves of the window, thereby enabling turning around of the window during simultaneous guiding by paired guide pins; and
the guide pins are horizontally movable and connected with paired bars, which via the motion connection being formed of a number of pivotably mounted links, are interconnected at upper and lower window portions, respectively, received in guide grooves for simultaneous parallel motion out and in, respectively, whereby locking and guiding of the window are provided by the single handle or lever.

8. The mechanism of claim 7, wherein the single handle or lever is configured for connection with the motion connection in an area of the single handle or lever.

9. The mechanism of claim 7, wherein motion transfer devices are arranged in corners of the [-shaped guide frames, the motion transfer devices deflecting straight motion by substantially 90°.

10. The mechanism of claim 9, wherein the motion transfer devices are connected with a projecting part of the paired bars.

11. The mechanism of claim 7, wherein the devices for locking the window are situated along vertical and/or horizontal sides of the window.

12. The mechanism of claim 7, wherein the devices for locking the window include locking pins interconnected with the devices for the guiding the window, or locking cremone bolts.

13. The mechanism of claim 8, wherein motion transfer devices are arranged in corners of the [-shaped guide frames, the motion transfer devices deflecting straight motion by substantially 90°.

14. The mechanism of claim 13, wherein the motion transfer devices are connected with a projecting part of the paired bars.

15. The mechanism of claim 13, wherein the devices for locking the window are situated along vertical and/or horizontal sides of the window.

16. The mechanism of claim 13, wherein the devices for locking the window include locking pins interconnected with the devices for the guiding the window, or locking cremone bolts.
